(19) United States
(12) Patent Application Publication
(10) Pub. No.: US 2009/0025999 A1
(43) Pub. Date: Jan. 29, 2009

(54) VEHICLE DOOR LOCK DEVICE

(75) Inventor: Katsuyuki ISHIGURO, Yamanashi (JP)

Correspondence Address: FOLEY AND LARDNER LLP;SUITE 500, 3000 K STREET NW, WASHINGTON, DC, 20007, US

(73) Assignee: MITSUI MINING & SMELTING CO., LTD.

(21) Appl. No.: 12/140,758

(22) Filed: Jun. 17, 2008

(30) Foreign Application Priority Data
Jul. 23, 2007 (JP) 2007-190980

(51) Int. Cl. E05B 65/20

(52) U.S. Cl. 180/287

(57) ABSTRACT

A vehicle door lock device includes a latching mechanism, a locking mechanism, and a child-lock mechanism. The child-lock mechanism is arranged between the latching mechanism and an inside door handle, and switches between a transmitting state and a non-transmitting state. The child-lock mechanism in the transmitting state transmits to the latching mechanism a force regarding an attempt to open a door by using the inside door handle, while the child-lock mechanism in the non-transmitting state does not transmit the force to the latching mechanism. When the latching mechanism receives the force, an inside-door handle lever causes the locking mechanism to switch to an unlocked state from a locked state. When the child-lock mechanism is in the transmitting state and the locking mechanism is in the locked state, a link lever and a panic lever operate the inside-door handle lever without transmitting the force to the latching mechanism.

### BACKGROUND OF THE INVENTION

1. Field of the Invention

The present invention relates to a vehicle door lock device.

2. Description of the Related Art

In recent years, a door lock actuator is used to switch a locking mechanism in a vehicle door lock device between a locked state and an unlocked state. In addition to the locking mechanism, a vehicle door lock device disclosed in Japanese Patent Application Laid-open No. 2001-20579 includes a child-lock mechanism from preventing a child from accidentally opening a door from inside the vehicle. The child-lock mechanism can be switched between a transmitting state and a non-transmitting state. The child-lock mechanism in the transmitting state transmits to a latching mechanism a signal regarding an attempt to open the door by using an inside door handle, while the child-lock mechanism in the non-transmitting state does not transmit the signal to the latching mechanism.

Meanwhile, in some of the conventional vehicle door lock devices, a key cylinder is not provided on the inside part of a door. As a result, the locking mechanism cannot be operated from inside the vehicle. Such a configuration enhances a security level of the vehicle against theft. That is, even if someone breaks a window of the vehicle, it becomes difficult to unlock the door from inside without the key cylinder.

However, in such a case, if the door lock actuator or a power supply system for the door lock actuator does not work properly due to a failure, it is difficult to unlock the locking mechanism if a key cylinder is not provided from inside the vehicle. Moreover, if the child-lock mechanism is switched to the non-transmitting state, then the latch of the door cannot be released. Thus, it is not possible to open the door from inside the vehicle when the door lock actuator does not work properly.

### SUMMARY OF THE INVENTION

It is an object of the present invention to at least partially solve the problems in the conventional technology.

According to an aspect of the present invention, a door lock device for a door of a vehicle, including an outside door handle arranged on an outer side of the door and an inside door handle arranged on an inner side of the door, includes a latching mechanism that, when the door is in a closed position, latches the door in a latched state and restricts movement of the door to an open position, a locking mechanism that is arranged between the latching mechanism and the outside door handle, and switches between a locked state and an unlocked state, the locking mechanism in the unlocked state transmitting to the latching mechanism a first force regarding an attempt to open the door by using the outside door handle, the locking mechanism in the locked state not transmitting the first force to the latching mechanism, the latching mechanism releasing the door from the latched state upon receiving the first force and allowing movement of the door to the open position, a door lock actuator that causes the locking mechanism to switch between the locked state and the unlocked state, a child-lock mechanism that is arranged between the latching mechanism and the inside door handle, and switches between a transmitting state and a non-transmitting state, the child-lock mechanism in the transmitting state transmitting to the latching mechanism a second force regarding an attempt to open the door by using the inside door handle, the child-lock mechanism in the non-transmitting state not transmitting the second force to the latching mechanism, an inside-door handle lever that operates when the latching mechanism receives the second force and causes the locking mechanism to switch to the unlocked state from the locked state, and a double action mechanism that, when the child-lock mechanism is in the transmitting state and the locking mechanism is in the locked state, operates the inside-door handle lever without transmitting the second force to the latching mechanism.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a vehicle door lock device according to a first embodiment of the present invention;

FIG. 2 is a schematic diagram of the vehicle door lock device when a child-lock mechanism is in a non-transmitting state;

FIG. 3 is a schematic diagram of the vehicle door lock device when a manually operated portion in a child-lock lever is positioned at a third position;

FIG. 4 is a schematic diagram of the vehicle door lock device in which the manually operated portion is released from the third position;

FIG. 5 is a plan view of a door of a vehicle in which the vehicle door lock device is configured to be installed;

FIG. 6 is a schematic diagram of a latching mechanism arranged in the vehicle door lock device;

FIG. 7A is a schematic diagram of an inside handle lever arranged in the vehicle door lock device;

FIG. 7B is a view of the inside handle lever from an arrow C shown in FIG. 7A;

FIG. 8 is a schematic diagram of a connect lever arranged in the vehicle door lock device;

FIG. 9A is a schematic diagram of a child-lock lever arranged in the vehicle door lock device;

FIG. 9B is a view of the child-lock lever from an arrow D shown in FIG. 9A;

FIG. 10A is a schematic diagram of a child-lock pin arranged in the vehicle door lock device;

FIG. 10B is a view of the child-lock pin from an arrow E shown in FIG. 10A;

FIG. 11A is a cross-sectional diagram of the vehicle door lock device along the line A-A;

FIG. 11B is a cross-sectional diagram of the vehicle door lock device along the line B-B;

FIG. 12 is a schematic diagram for explaining a locking mechanism in a locked state;

FIG. 13 is a schematic diagram for explaining a case in which the door is opened by using an inside door handle when the lock mechanism is in the locked state;

FIG. 14 is a schematic diagram for explaining a case in which the inside door handle is released;

FIG. 15 is a schematic diagram for explaining a case in which the door is opened by using released inside door handle;

FIG. 16 is an enlarged view of main parts of the vehicle door lock device in FIG. 1;

FIG. 17 is an enlarged view of main parts of the vehicle door lock device in FIG. 2;

FIG. 18 is an enlarged view of main parts of the vehicle door lock device in FIG. 3;

FIG. 19 is an enlarged view of main parts of the vehicle door lock device in FIG. 4; and

FIG. 20 is a schematic diagram for explaining a case in which the door is opened by using the inside door handle when the manually operated portion is released from the third position.

### DETAILED DESCRIPTION OF THE PREFERRED EMBODIMENTS

Exemplary embodiments of the present invention are described in detail below with reference to the accompanying drawings. The present invention is not limited to these exemplary embodiments.

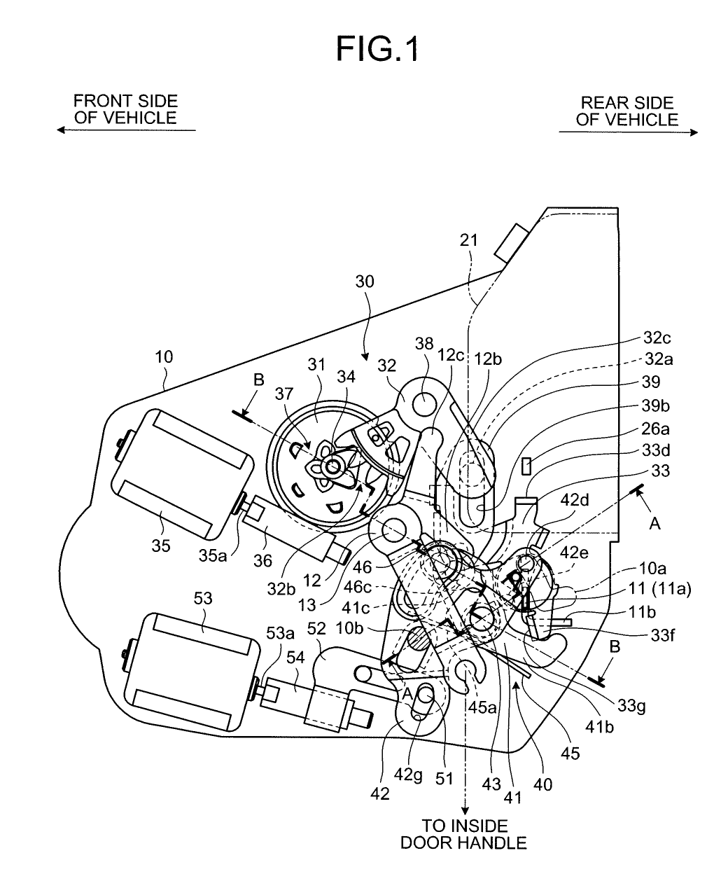

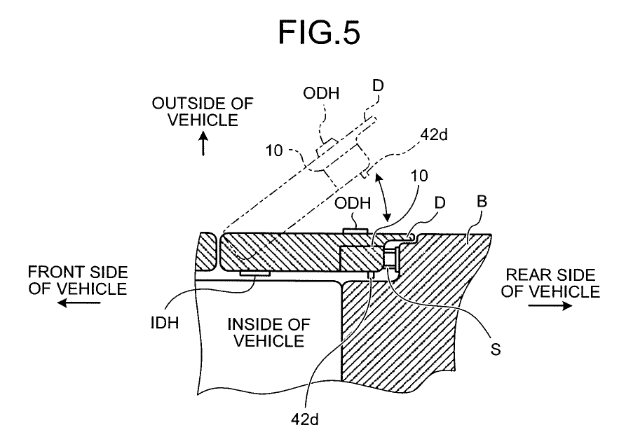

FIGS. 1 to 4 are schematic diagrams of a vehicle door lock device according to a first embodiment of the present invention. The vehicle door lock device includes a door-lock case 10. A latch case 21 is fixed to the door-lock case 10 and includes a latching mechanism 20 in its inside. The vehicle door lock device is configured to be installed in a front-hinged door D at the right backseat of a vehicle body B of a four-wheeled vehicle (see FIG. 5).

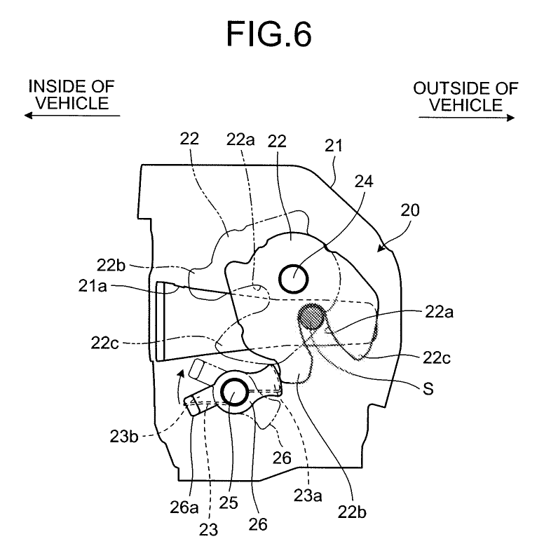

The latching mechanism 20 engages with a striker S arranged in the vehicle body B, and includes a latch 22 and a ratchet 23 (see FIGS. 5 and 6).

The latch 22 is rotatably arranged around a latch shaft 24 and at a position above a striker groove 21a arranged in the latch case 21. The latch shaft 24 is arranged substantially horizontal along the anteroposterior direction of the vehicle body B. The latch 22 includes a depression-for-engagement 22a, a hook portion 22b, and a locking portion 22c. The depression-for-engagement 22a is a depression from the outer circumference of the latch 22 in the direction of the latch shaft 24. The width of the depression-for-engagement 22a is large enough to accommodate therein the striker S. The hook portion 22b is a portion which locates inside the vehicle of the depression-for-engagement 22 when the latch 22 is positioned such that the depression-for-engagement 22a is open downwards. Meanwhile, if the latch 22 is rotated in anticlockwise direction to a maximum extent as shown by a full line in FIG. 6, the hook portion 22b rests after passing transversely across the striker groove 21a. On the other hand, if the latch 22 is rotated in clockwise direction to a maximum extent as shown by a dashed-two dotted line in FIG. 6, the hook portion 22b rests at a position where the striker groove 21a is in a released state. Regarding the locking portion 22c, the locking portion 22c is a portion which locates on the outside the vehicle of the depression-for-engagement 22a when the latch 22 is positioned such that the depression-for-engagement 22a is open downwards. When the latch 22 is rotated in clockwise direction to a maximum extent as shown by the dashed-two dotted line in FIG. 6, the locking portion 22c passes transversely across the striker groove 21a and rests at a slightly upward-inclined position in the outward direction with respect to the striker groove 21a. A latch spring (not shown) is arranged between the latch 22 and the latch case 21 such that the latch 22 is maintained biased in clockwise direction with reference to FIG. 6.

The ratchet 23 is rotatably arranged around a ratchet shaft 25 that lies substantially horizontal along the anteroposterior direction of the vehicle body B. The ratchet 23 is arranged beneath the striker groove 21a and on the vehicle-side with respect to the latch shaft 24. The ratchet 23 includes an engaging portion 23a and a working portion 23b. The engaging portion 23a extends outward in a radial direction from the ratchet shaft 25 toward the outside of the vehicle. When the ratchet 23 rotates around the ratchet shaft 25, the engaging portion 23a can detachably engage with the hook portion 22b and the locking portion 22c of the latch 22. The working portion 23b extends inward in a radial direction toward the inside of vehicle from the ratchet shaft 25. A ratchet lever 26 is attached to the ratchet 23 at an anterior position and rotates therewith around the ratchet shaft 25 in an integrated manner. The ratchet lever 26 includes a ratchet abutting portion 26a that extends in the same direction as that of the working portion 23b. A ratchet spring (not shown) is arranged between the ratchet 23 and the latch case 21 such that the ratchet 23 is maintained biased in anticlockwise direction with reference to FIG. 6.

When the door D is in an open position as shown by a dashed-two dotted line in FIG. 5, the latch 22 remains positioned in such a way that the striker groove 21a is in the released state as shown by the dashed-two dotted line in FIG. 6. When the door D is moved to a closed position as shown by a full line in FIG. 5, the striker S attached to the vehicle body B fits into the striker groove 21a of the latch case 21 and then abuts against the locking portion 22c of the latch 22 as shown in FIG. 6. As a result, the latch 22 rotates in anticlockwise direction by opposing the biasing force of the latch spring. Meanwhile, because of the biasing force of the ratchet spring, the engaging portion 23a comes in sliding contact with the outer circumference of the latch 22 and the ratchet 23 rotates around the ratchet shaft 25 depending on the shape of the outer circumference of the latch 22. When the door D is further moved to the closed position, the striker S gradually enters deeper into the striker groove 21a. The engaging portion 23a eventually reaches the position of the depression-for-engagement 22a and the hook portion 22b abuts against the engaging portion 23a as shown by the full line in FIG. 6. As a result, the clockwise rotation of the latch 22 is prevented by opposing the biasing restoring force of the latch spring. In this case, because the hook portion 22b rests at a position after passing transversely across the striker groove 21a, the striker S is prevented from disengaging towards the outward direction from the striker groove 21a. Thus, the door D is maintained at the closed position with respect to the door vehicle B. That is, the door D is maintained in a latched state.

When the ratchet abutting portion 26a is rotated upwards with reference to FIG. 6 from the latched state of the door D by opposing the biasing force of the ratchet spring, the hook portion 22b detaches from the engaging portion 23a and the latch 22 rotates in clockwise direction because of the biasing restoring force of the latch spring. As a result, the striker S disengages from the striker groove 21a and rests in the released state. Thus, it becomes possible to move the door D in the open position with respect to the vehicle body B.

The door-lock case 10 includes an open lever 11, an inside handle lever 12, and a locking mechanism 30 as shown in FIG. 1.

The open lever 11 is rotatably arranged around an open lever shaft (not shown) that lies substantially horizontal along the anteroposterior direction of the vehicle body B. The open lever 11 includes an operating end 11a and a pressure receiving portion 11b. The operating end 11a is arranged beneath of the ratchet abutting portion 26a of the ratchet lever 26. The pressure receiving portion 11b extends beneath of the operating end 11a and bends towards the rear side of the vehicle body B. When an attempt is made to open the door D by using an outside door handle (ODH), which is fixed on the outer surface of the door D (see FIG. 5), the open lever 11 rotates via appropriate linkage (not shown) such that the operating end 11a and the pressure receiving portion 11b move upwards with reference to FIG. 1. An open lever spring (not shown) is arranged between the open lever 11 and the door-lock case 10 such that the operating end 11a and the pressure receiving portion 11b are maintained biased in downward direction with reference to FIG. 1.

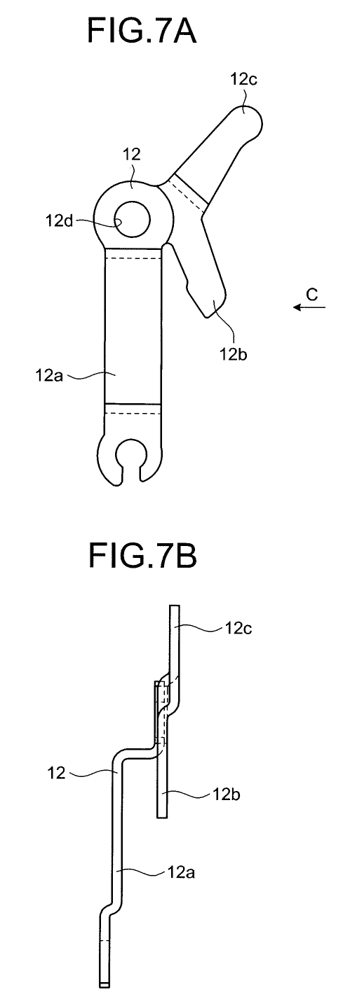

The inside handle lever 12 is pivotably arranged around an inside lever shaft 13 and at a position anterior to the open lever 11 on the vehicle body B. The inside lever shaft 13 lies substantially horizontal along the width direction of the vehicle body B. As shown in FIG. 7A, the inside handle lever 12 includes a working end 12a, an inside-handle lock linkage portion 12b, a sector lever abutting portion 12c, and an inside-lever shaft hole 12d. The working end 12a extends downwards from the inside lever shaft 13, bends towards the vehicle-side, and further extends downwards (see FIGS. 1 and 7B). The working end 12a is linked with an inside door handle (IDH) shown in FIG. 5 via an appropriate linkage (not shown). When an attempt is made to open the door D by using the inside door handle IDH, the inside handle lever 12 pivots in clockwise direction with reference to FIG. 1. The inside-handle lock linkage portion 12b and the sector lever abutting portion 12c extend from the inside lever shaft 13 towards the rear side of the vehicle body B and fork in two directions (see FIG. 1). The inside-handle lock linkage portion 12b forks downwards, while the sector lever abutting portion 12c forks upwards. The inside-lever shaft hole 12d has a diameter large enough for the inside lever shaft 13 to be inserted therethrough.

The locking mechanism 30 switches between an unlocked state and a locked state. During the unlocked state, the locking mechanism 30 transmits to the latching mechanism 20 force of the rotation of the open lever 11 due to an attempt to open the door D by using the outside door handle ODH. On the other hand, during the locked state, the locking mechanism 30 does not transmit the force to the latching mechanism 20. The locking mechanism 30 includes a worm wheel 31, a sector lever 32, and a link lever 33 (double action mechanism).

The worm wheel 31 is rotatably arranged around a wheel shaft 34 and at a position anterior to the inside handle lever 12. The wheel shaft 34 lies substantially horizontal along the width direction of the vehicle body B. The worm wheel 31 engages with a first worm 36 that is fixed to a first output shaft 35a of a first electric motor 35 (lock actuator). An intermittent gear wheel 37 is fixed to the coaxial core of the worm wheel 31. The intermittent gear wheel 37 forms a one-direction intermittent drive-line mechanism with an intermittent driven gear 32b of the sector lever 32. A neutrality spring 31a is arranged between the worm wheel 31 and the door-lock case 10 such that the worm wheel 31 is maintained in a predetermined neutral state.

The sector lever 32 is rotatably arranged around a sector lever shaft 38 and at a position posterior to the worm wheel 31. The sector lever shaft 38 lies substantially horizontal along the width direction of the vehicle body B. The sector lever 32 has a sector-shaped portion in the anterior direction, and includes a coupling pin 32a, the intermittent driven gear 32b, and an inside-handle-lever abutting portion 32c. The coupling pin 32a is a columnar protrusion at a surface of the sector lever 32 that faces in the outward direction and extends substantially horizontal along the width direction of the vehicle body B. The intermittent driven gear 32b is a toothed gear on the arc-like circumference of the sector lever 32 and engages with the intermittent gear wheel 37. The inside-handle-lever abutting portion 32c is an inward salient from the rear edge portion of the sector lever 32. When the inside handle lever 12 pivots in clockwise direction with reference to FIG. 1, the inside-handle-lever abutting portion 32c abuts against the sector lever abutting portion 12c.

The intermittent drive-line mechanism between the intermittent driven gear 32b and the intermittent gear wheel 37 arbitrarily rotates the worm wheel 31 such that the sector lever 32 can pivot in an arbitrary direction. Moreover, the intermittent drive-line mechanism is configured such that the sector lever 32 pivots without any power transmission from the intermittent driven gear 32b to the intermittent gear wheel 37 and without any rotation of the worm wheel 31.

The link lever 33 includes a link lever body 33a and a link lever hole 33b. The link lever hole 33b is arranged at the bottom end of the link lever body 33a. The operating end 11a is inserted through the link lever hole 33b such that the link lever 33 can move vertically along with the operating end 11a and the pressure receiving portion 11b, and pivot with respect to the operating end 11a around a shaft center in the width direction of the vehicle body B. The panic lever is provided with a panic lever abutting portion 33c and a ratchet driving portion 33d. The panic lever abutting portion 33c bends from the anterior end of the link lever body 33a towards the inside vehicle. The ratchet driving portion 33d is an engaging portion on the link lever body 33a. The ratchet driving portion 33d is arranged vertically above the link lever hole 33b such that it lies adjacent to and faces to the bottom end of the ratchet abutting portion 26a.

The link lever 33 includes a lock lever portion 33f. The lock lever portion 33f extends downwards from the link lever hole 33b and then bends towards the vehicle-inside, in case that the latchet driving portion 33d is placed vertically upward of the link lever hole 33b. The lock lever portion 33f includes an operation abutting surface 33g on the front side of the vehicle. The operation abutting surface 33g is configured to slightly incline downward toward the front, in case that the latchet driving portion 33d is placed vertically upward of the link lever hole 33b.

The link lever 33 is linked to a panic lever 39 (a double action mechanism). The panic lever 39 includes a panic lever shaft 39a. The panic lever shaft 39a extends from an end surface on the outside vehicle of the panic lever 39 along a substantially horizontal axis in the width direction of the vehicle body B. The panic lever shaft 39a is inserted through a hole (not shown) of the link lever 33 such that the panic lever 39 can pivot around the panic lever shaft 39a. The anterior end surface of the panic lever 39 abuts against the panic lever abutting portion 33c. The panic lever shaft 39a is provided with a linking slit 39b. The linking slit 39b is a slit formed along a vertical direction of the panic lever 39 to movably fit the coupling pin 32a of the sector lever 32 therein. A panic spring (not shown) is arranged between the link lever 33 and the panic lever 39 such that the anterior end surface of the panic lever 39 is maintained to abut against the panic lever abutting portion 33c.

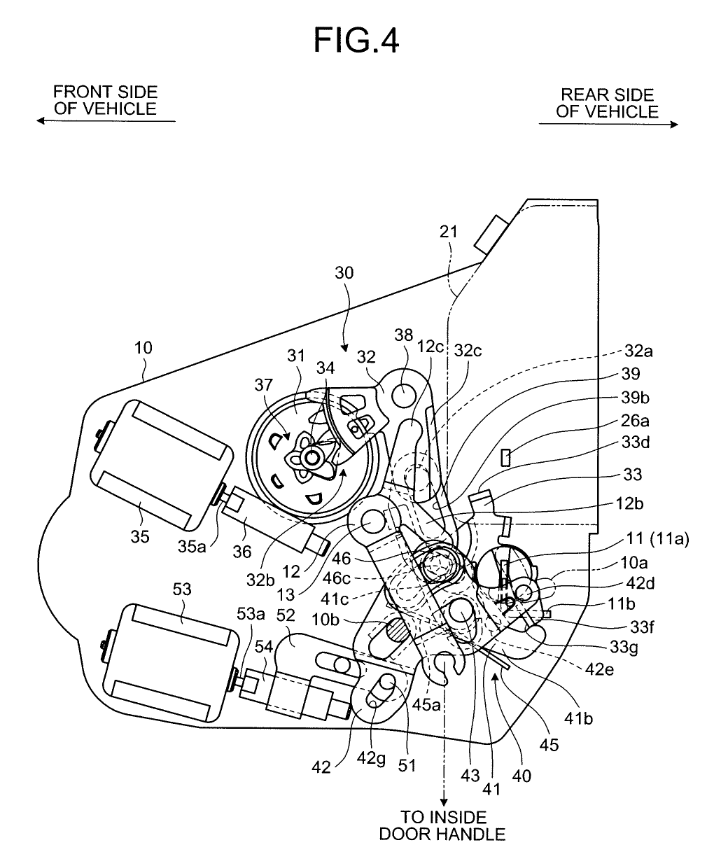

As shown in FIG. 4, the door lock device above includes a child-lock mechanism 40 inside the door-lock case 10. The child-lock mechanism 40 switches between a transmitting state and a non-transmitting state. During the transmitting state, the child-lock mechanism 40 transmits to the latching mechanism 20 a force caused by an attempt to open the door D by using the inside door handle IDH. On the other hand, during the non-transmitting state, the child-lock mechanism 40 does not transmit to the latching mechanism 20 the force caused by an attempt to open the door D by using the inside door handle IDH. The child-lock mechanism 40 includes a connect lever 41, a child-lock lever 42, and a child-lock pin 46.

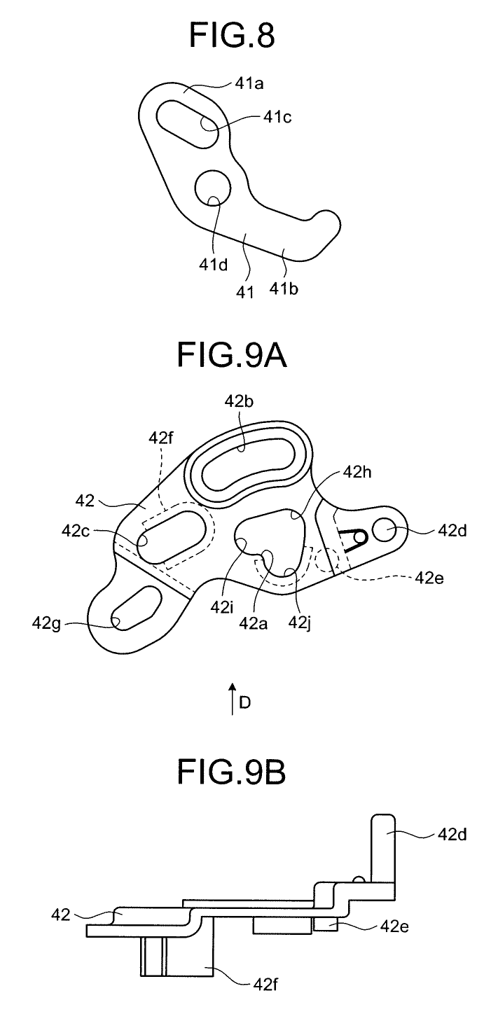

The connect lever 41 is pivotably arranged around a connect lever shaft 43, and lies between the inside handle lever 12 and the link lever 33. The connect lever shaft 43 lies substantially horizontal along the width direction of the vehicle body B. As shown in FIG. 8, the connect lever 41 includes an accommodating end 41a, a transmitting end 41b, and a connect-lever shaft hole 41d. The accommodating end 41a extends upwards from the connect lever shaft 43 and includes a pin accommodating slit 41c (see FIGS. 1 and 8). When the inside-handle lock linkage portion 12b pivots around the inside lever shaft 13, the anterior end of the inside-handle lock linkage portion 12b gets accommodated into the pin accommodating slit 41c, while the rear end thereof lies outside of the pivoting area of the pin accommodating slit 41c. The transmitting end 41b has a slight posterior declination from the connect lever shaft 43 and then a slight posterior inclination. The slightly inclined portion of the transmitting end 41b lies beneath the pressure receiving portion 11b. The connect-lever shaft hole 41d has a diameter large enough for the connect lever shaft 43 to be inserted therethrough.

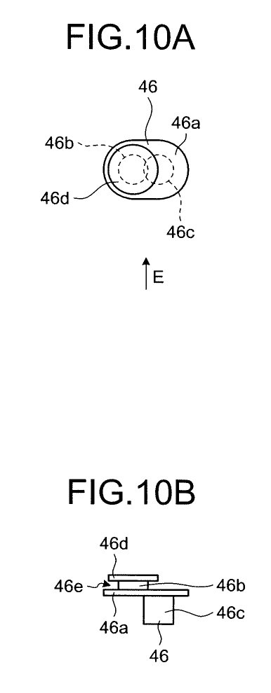

The child-lock lever 42 is pivotably arranged around a shaft center extending in the width direction of the vehicle body B such that the child-lock lever 42 overlaps the connect lever 41, and lies between the connect lever 41 and the door-lock case 10. The child-lock lever 42 pivots in the width direction in an arc-like manner and moves along the anteroposterior direction of the vehicle body B. As shown in FIG. 9A, the child-lock lever 42 includes a slide groove 42a, a child-lock pin slit 42b, a child-lock lever-shaft slit 42c, a manually operated portion 42d, a lock operating portion 42e, a restoring-spring abutting portion 42f, and a power child-lock slit 42g.

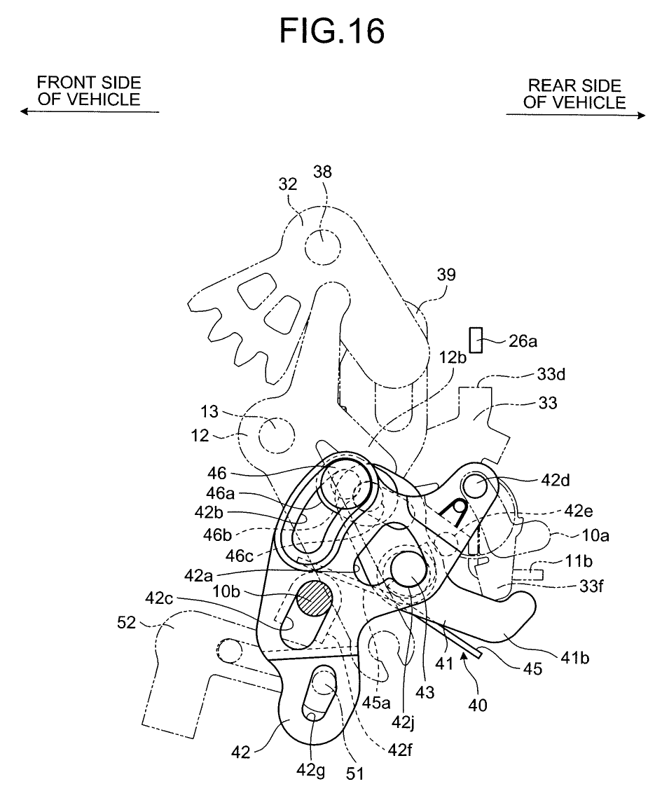

The slide groove 42a is an inverted V-shaped groove through which the connect lever shaft 43 can be inserted (see FIG. 16). The slide groove 42a includes a child lock portion 42h in the top portion, an emergency lock portion 42i in the anterior portion, and an unlock portion 42j in the bottom portion as shown in FIG. 9A. After passing through the slide groove 42a, the connect lever shaft 43 is positioned alternatively at the child lock portion 42h, the emergency lock portion 42i, and the unlock portion 42j as shown in FIGS. 1, 2, and 3, respectively.

The child-lock pin slit 42b extends from the top portion of the child-lock lever 42 toward the anterior portion of the vehicle and along the longitudinal direction of the child-lock lever 42.

The child-lock lever-shaft slit 42c is arranged in an anterior portion side of the vehicle with respect to the connect lever shaft 43 such that a child-lock lever shaft 10b can be inserted from an interior side of the door-lock case 10 (see FIG. 16). The child-lock lever shaft 10b extends from the vehicle-side surface of the door-lock case 10 and lies substantially horizontal along the width direction of the vehicle body B. The child-lock lever-shaft slit 42c is configured to allow that the child-lock lever shaft 10b move along longitudinal direction of the child-lock lever-shaft slit 42c.

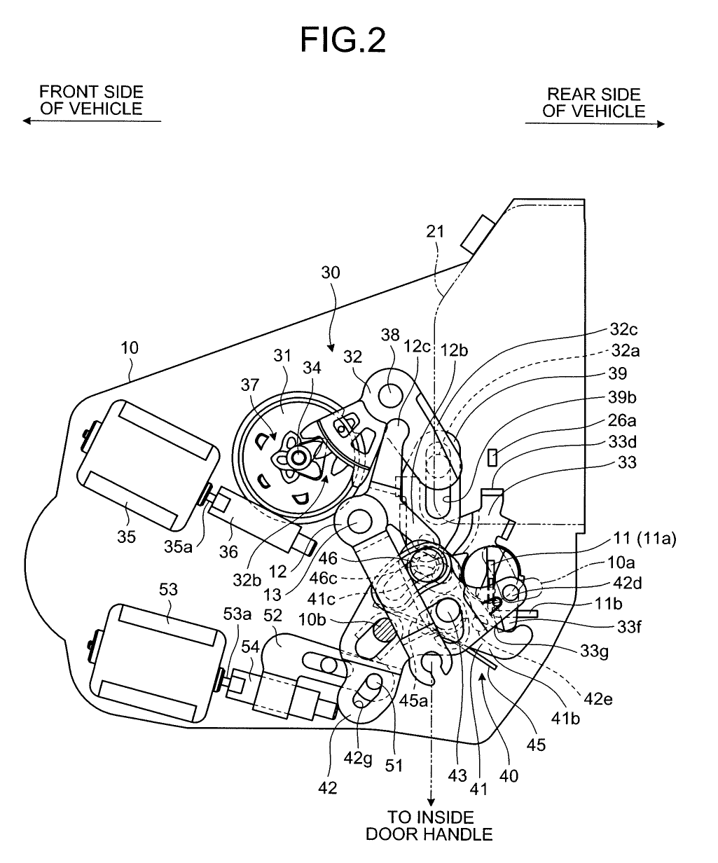

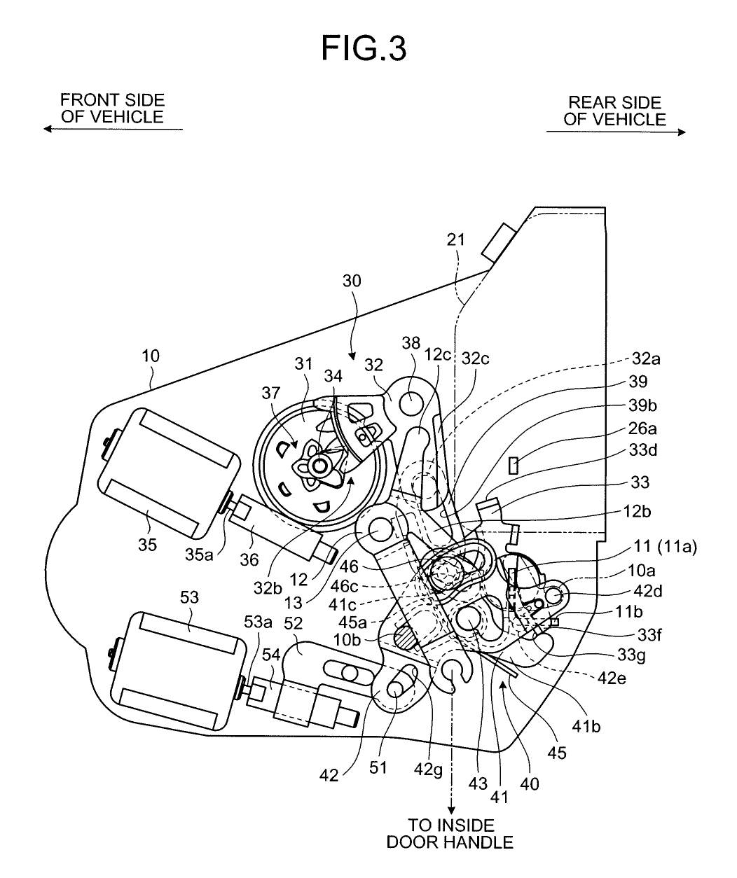

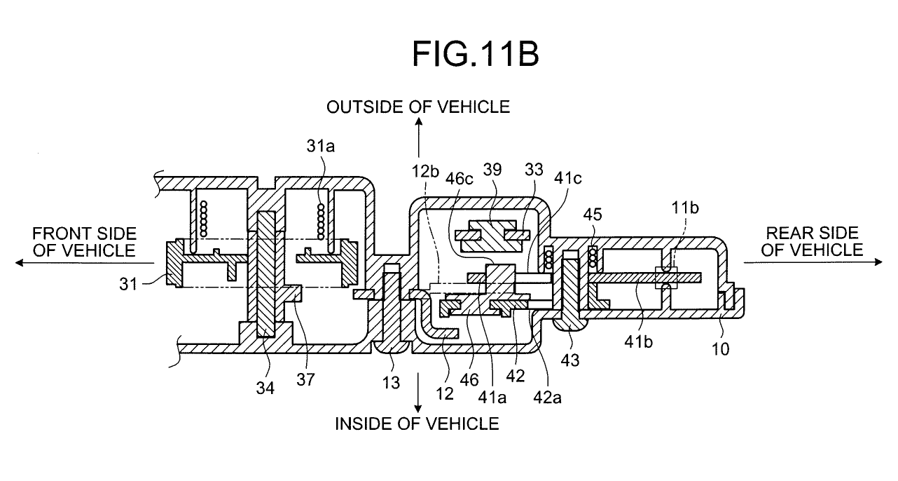

The manually operated portion 42d is a columnar portion extending from the interior side surface of the child-lock lever 42 and lies substantially horizontal along the width direction of the vehicle body B (see FIG. 11A). The manually operated portion 42d protrudes outside the vehicle body B through a lock-case hole 10a of the door-lock case 10 and an opening of a panel (not shown) of the door D. Due to such a configuration, it is possible to pivot the child-lock lever 42 in an arc-like manner around the shaft center in the width direction of the vehicle body B and move along the anteroposterior direction of the vehicle body B from outside of the door D. As shown in FIG. 5, the manually operated portion 42d is arranged at the inside surface of the door D in such a manner that, when the door D is in the closed position, the manually operated portion 42d remains in a blocked state. As shown in FIG. 1, the lock-case hole 10a is a substantially L-shaped opening that specifies the positions of the manually operated portion 42d in the child-lock lever 42. The position of the manually operated portion 42d above the lock-case hole 10a as shown in FIG. 1 is referred to as a first position. The manually operated portion 42d can pivot downwards around the shaft center in the width direction of the vehicle body B in an arc-like manner to a second position as shown in FIG. 2. The manually operated portion 42d can further move inside the lock-case hole 10a towards the rear side of the vehicle body B to a third position as shown in FIG. 3.

The lock operating portion 42e is a protrusion at the end portion on the vehicle posterior side of the child-lock lever 42 extending outward of the vehicle body B (see FIGS. 1 and 9B). When the manually operated portion 42d is positioned at either one of the first position and the second position, the lock operating portion 42e is distantly positioned from the operation abutting surface 33g of the lock lever 33f which is slightly anteverted toward the front of vehicle as shown in FIG. 1 and FIG. 2. On the other hand, when the manually operated portion 42d is positioned at the third position, the lock operating portion 42e is positioned such that the link lever 33 is rotated in anticlockwise direction via the operation abutting surface 33g and the locking mechanism 30 is switched to the locked state as shown in FIG. 3.

The restoring-spring abutting portion 42f is a salient at the end part of the child-lock lever shaft slit 42c in the outward direction of the vehicle body B (see FIG. 11A).

The power child-lock slit 42g is arranged at the bottom end of the child-lock lever 42.

Meanwhile, a restoring spring 45 is arranged between the child-lock lever 42 and the door-lock case 10 such that the child-lock lever 42 is maintained biased in anticlockwise direction around the connect lever shaft 43 (see FIG. 1). The restoring spring 45 is arranged via the connect lever shaft 43 at a position in the outward direction with respect to the connect lever 41. The restoring spring 45 includes a spring-action working portion 45a. Because of the biasing restoring force of the restoring spring 45, the spring-action working portion 45a biases the restoring-spring abutting portion 42f in anticlockwise direction around the connect lever shaft 43.

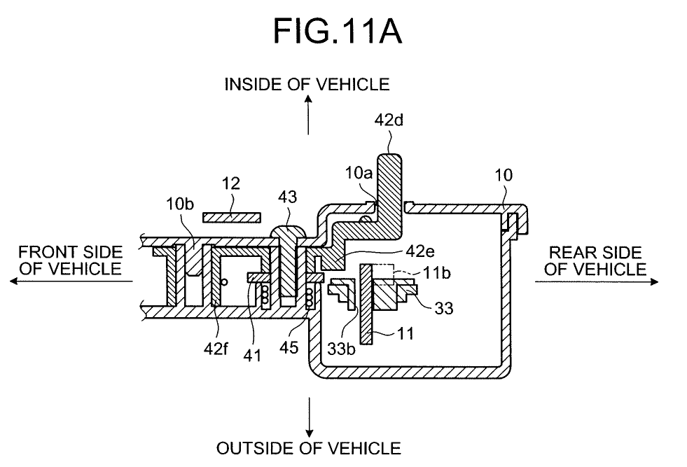

The child-lock pin 46 is fixed to the child-lock lever 42 (see FIG. 1). As shown in FIGS. 10A and 11B, the child-lock pin 46 includes a pin base portion 46a, a fixing pin 46b, and a transmitting pin 46c. The pin base portion 46a is a portion between the connect lever 41 and the child-lock lever 42. The fixing pin 46b is a columnar protrusion at the vehicle-side surface of the pin base portion 46a and extends substantially horizontal along the width direction of the vehicle body B. A stopper portion 46d lies at the protruded end of the fixing pin 46b and has a larger diameter than the fixing pin 46b (see FIGS. 10B and 11B). The pin base portion 46a, the fixing pin 46b, and the stopper portion 46d combinedly form a fixing groove 46e. The end part of the child-lock pin slit 42b fits into the fixing groove 46e. As a result, the child-lock pin 46 is movably fixed along the longitudinal direction of the child-lock pin slit 42b (see FIG. 10B). The transmitting pin 46c is a columnar protrusion at a surface of the pin base portion 46a that faces in the outward direction and extends substantially horizontal along the width direction of the vehicle body B. The transmitting pin 46c passes through the pin accommodating slit 41c and the protruded end thereof protrudes thorough the surface of the inside-handle lock linkage portion 12b facing in the outward direction (see FIG. 11B). When the manually operated portion 42d is positioned at the first position, the transmitting pin 46c is arranged within the pivoting area of the inside-handle lock linkage portion 12b. On the other hand, when the manually operated portion 42d is positioned at either of the second position and the third position, the transmitting pin 46c is arranged outside the pivoting area of the inside-handle lock linkage portion 12b.

A power child-lock pin 51 is inserted through the power child-lock slit 42g. The power child-lock pin 51 is a columnar protrusion at the vehicle-side surface of a power child-lock lever 52 and extends substantially horizontal along the width direction of the vehicle body B. When a second worm 54, which is fixed to a second output shaft 53a of a second electric motor 53, rotates, the power child-lock lever 52 and the power child-lock pin 51 move along the longitudinal direction of the second worm 54.

The locking mechanism 30 shown in FIG. 1 is in the unlocked state. During the unlocked state, the ratchet driving portion 33d is arranged vertically above the link lever hole 33b such that it adjacently faces to the bottom end of the ratchet abutting portion 26a. When an attempt is made to open the door D by using the outside door handle ODH and the link lever body 33a moves upwards due to the rotation of the open lever 11, the ratchet driving portion 33d abuts against the ratchet abutting portion 26a such that the ratchet abutting portion 26a is rotated upwards. As a result, the latching mechanism 20 is released from the latched state and the door D is opened with respect to the vehicle body B.

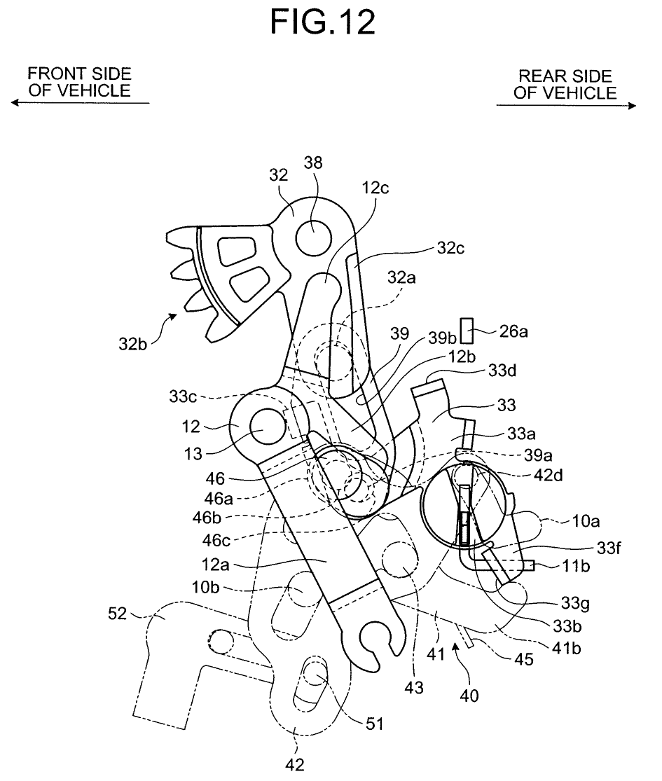

During the unlocked state, when the worm wheel 31 is rotated in anticlockwise direction by the first electric motor 35, the sector lever 32 pivots in clockwise direction around the sector lever shaft 38. As a result, the coupling pin 32a and the link lever 33, which is linked via the panic lever 39, pivot in anticlockwise direction around the link lever hole 33b. The locking mechanism 30 thus switches to the locked state as shown in FIG. 12.

During the locked state, the ratchet driving portion 33d moves away from the position adjacent to the bottom end of the ratchet abutting portion 26a. Thus, even if an attempt is made to open the door D by using the outside door handle ODH and the link lever body 33a moves upwards due to the rotation of the open lever 11, the ratchet driving portion 33d does not abut against the ratchet abutting portion 26a. Thus, as long as the latching mechanism 20 is in the locked state, the door D is maintained at the closed position with respect to the door vehicle B.

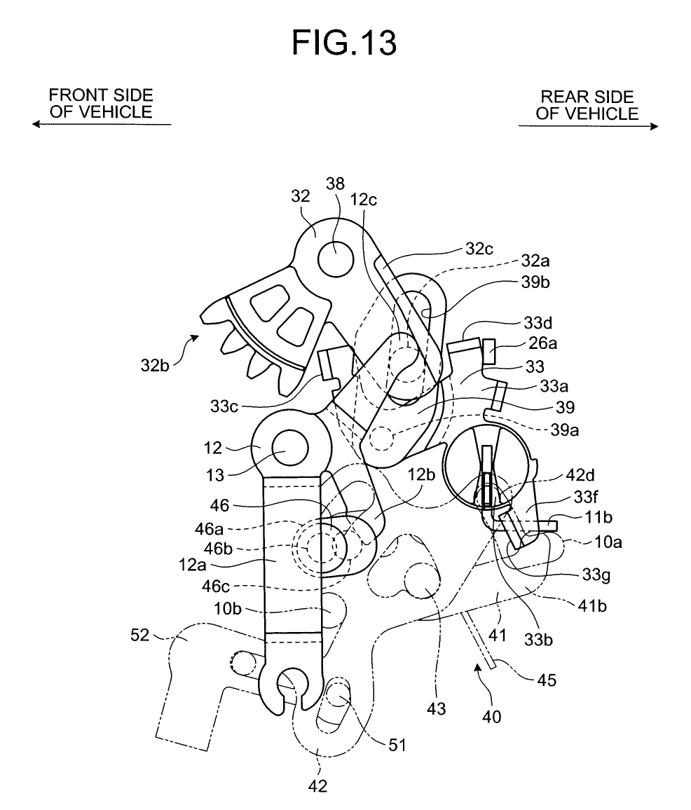

Meanwhile, during the locked state, the transmitting pin 46c is arranged within the pivoting area of the inside-handle lock linkage portion 12b. When an attempt is made to open the door D by using the inside door handle IDH, the inside-handle lock linkage portion 12b moves the transmitting pin 46c downwards, while the sector lever abutting portion 12c moves the inside-handle-lever abutting portion 32c towards the rear side of the vehicle body B. Consequently, the connect lever 41, through which the transmitting pin 46c is inserted, pivots in anticlockwise direction with reference to FIG. 12 such that the transmitting end 41b moves upwards. As a result, the link lever 33 also moves upwards via the pressure receiving portion 11b. When the inside-handle-lever abutting portion 32c moves towards the rear side of the vehicle body B, the sector lever 32 pivots in anticlockwise direction with reference to FIG. 12 and the coupling pin 32a moves towards the rear side of the vehicle body B. Thus, the panic lever 39 pivots in clockwise direction. In that case, because the ratchet driving portion 33d abuts against the anterior side of the ratchet abutting portion 26a as shown in FIG. 13, the panic lever 39 is detached from the panic lever abutting portion 33c by opposing the biasing restoring force of the panic spring. The panic lever 39 then pivots in clockwise direction with reference to FIG. 12.

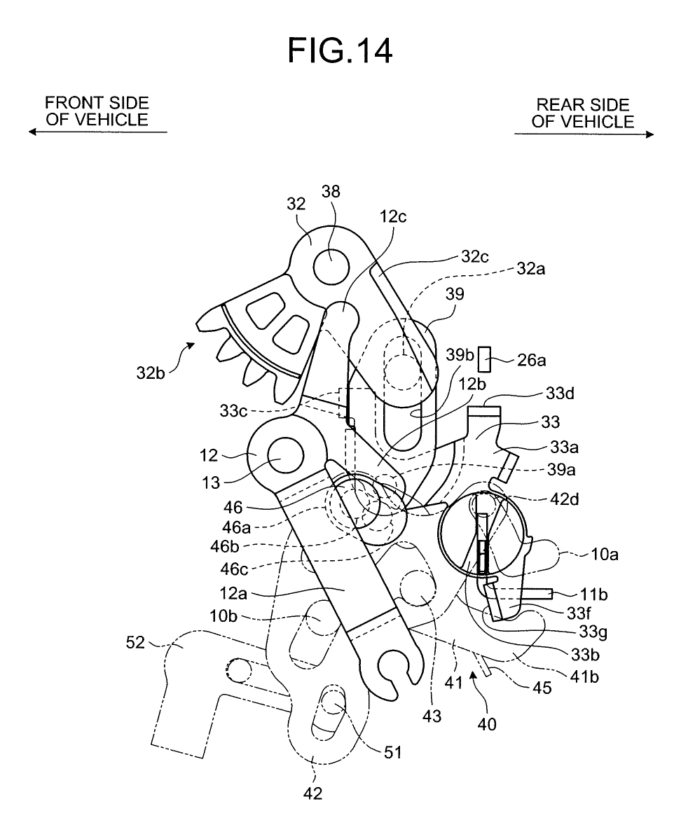

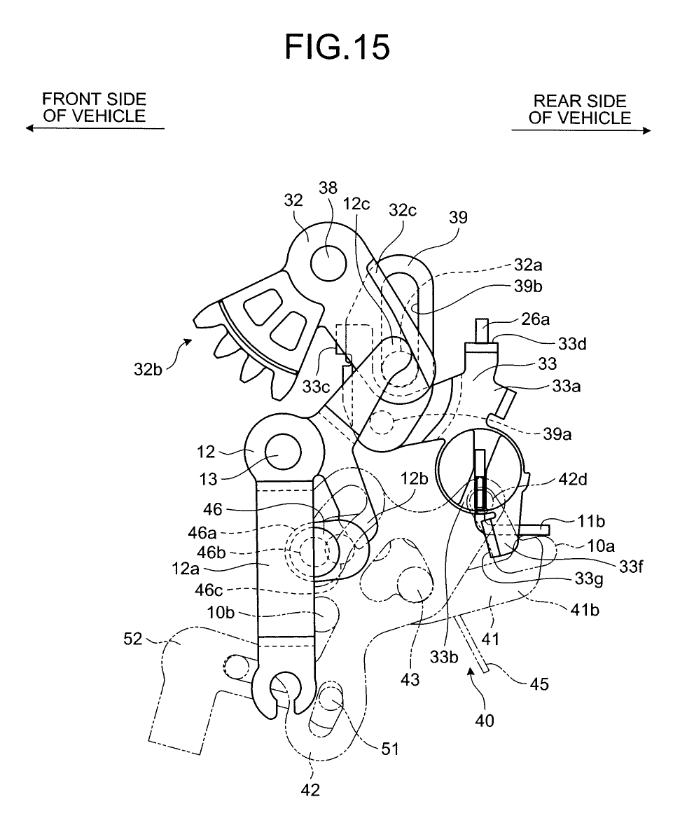

When the inside door handle IDH is released, the link lever 33 moves such that the panic lever abutting portion 33c re-abuts against the anterior surface of the panic lever 39 due to the biasing restoring force of the panic spring. Moreover, the operating end 11a and the pressure receiving portion 11b move downward due to the biasing restoring force of the open lever spring. As a result, the transmitting end 41b moves downward via the pressure receiving portion 11b and the transmitting pin 46c is rearranged within the pivoting area of the inside-handle lock linkage portion 12b. When the panic lever abutting portion 33c re-abuts against the anterior surface of the panic lever 39, the ratchet driving portion 33d is arranged vertically above the link lever hole 33b such that it lies adjacent to the bottom end of the ratchet abutting portion 26a. That is, the locking mechanism 30 switches to the unlocked state. During the unlocked state, when an attempt is made to open the door D by using the inside door handle IDH, the inside-handle lock linkage portion 12b moves the transmitting pin 46c downwards. Consequently, the connect lever 41, through which the transmitting pin 46c is inserted, pivots in anticlockwise direction with reference to FIG. 14 such that the transmitting end 41b moves upwards. The link lever 33 also moves upwards via the pressure receiving portion 11b. As a result, the link lever 33 abuts against the ratchet abutting portion 26a as shown in FIG. 15 and the latching mechanism 20 is released from the latched state. Because of such double action mechanism, the door D can be opened by using the inside door handle IDH.

During the locked state shown in FIG. 12, when the worm wheel 31 is rotated in clockwise direction by the first electric motor 35, the sector lever 32 pivots in anticlockwise direction around the sector lever shaft 38. As a result, the coupling pin 32a and the link lever 33, which is linked via the panic lever 39, pivot in clockwise direction around the link lever hole 33b. The locking mechanism 30 thus re-switches to the unlocked state as shown in FIG. 1.

Meanwhile, the child-lock mechanism 40 shown in FIGS. 1 and 16 is in the transmitting state. During the transmitting state, the transmitting pin 46c is arranged within the pivoting area of the inside-handle lock linkage portion 12b. When an attempt is made to open the door D by using the inside door handle IDH, the inside-handle lock linkage portion 12b moves the transmitting pin 46c downwards. Consequently, the connect lever 41, through which the transmitting pin 46c is inserted, pivots in anticlockwise direction with reference to FIGS. 1 and 16 such that the transmitting end 41b moves upwards. The link lever 33 also moves upwards via the pressure receiving portion 11b. As a result, if the locking mechanism 30 is in the unlocked status, the link lever 33 abuts against the ratchet abutting portion 26a such that the latching mechanism 20 is released from the latched state. Thus, the door D can be opened by using the inside door handle IDH.

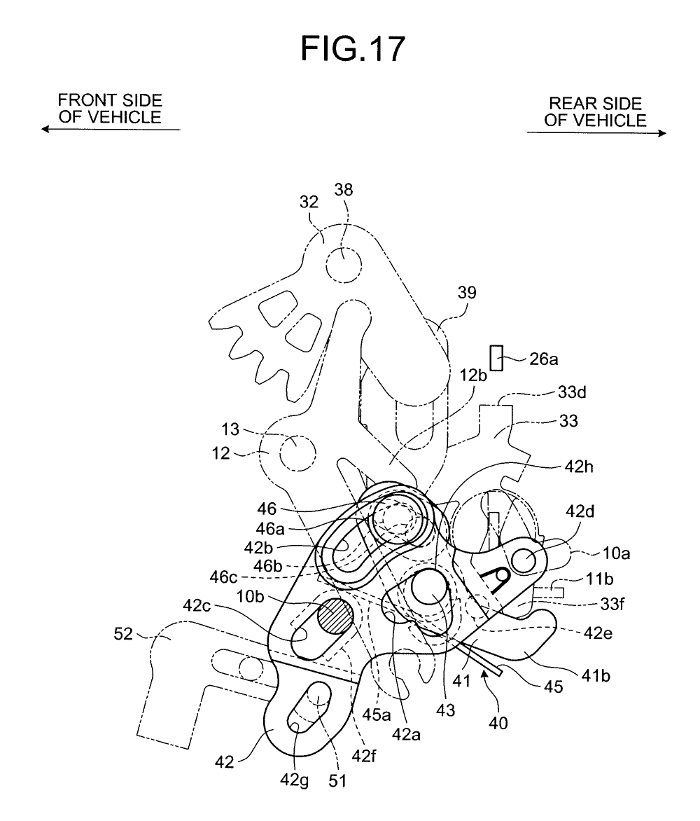

When the manually operated portion 42d is moved from the first position as shown in FIGS. 1 and 16 to the second position as shown in FIGS. 2 and 17 in an arc-like manner around the shaft center in the width direction of the vehicle body B, the child-lock lever 42 pivots around the child-lock lever shaft 10b in clockwise direction with reference to FIGS. 1 and 16 such that the connect lever shaft 43 is positioned at the child lock portion 42h. That is, the child-lock mechanism 40 switches to the non-transmitting state. During the non-transmitting state, the transmitting pin 46c is arranged outside the pivoting area of the inside-handle lock linkage portion 12b. Thus, even if an attempt is made to open the door D by using the inside door handle IDH, the transmitting pin 46c does not abut against the inside-handle lock linkage portion 12b and the connect lever 41 does not pivot. As a result, the door D cannot be opened.

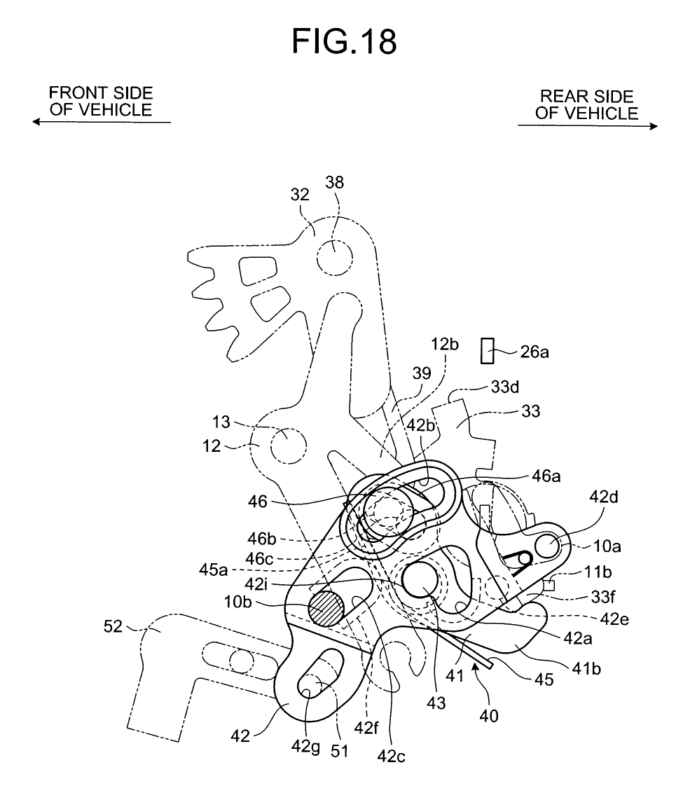

Moreover, when the manually operated portion 42d is further moved from the second position shown in FIGS. 2 and 17 to the third position, i.e., towards the rear side of the vehicle body B by opposing the biasing restoring force of the restoring spring 45 (see FIGS. 3 and 18), the child-lock lever 42 moves further to the rear side such that the connect lever shaft 43 is positioned at the emergency lock portion 42i. In that case, the non-transmitting state of the child-lock mechanism 40 is maintained. Because the transmitting pin 46c is maintained outside the pivoting area of the inside-handle lock linkage portion 12b, the transmitting pin 46c does not abut against the inside-handle lock linkage portion 12b and the connect lever 41 does not pivot even if an attempt is made to open the door D by using the inside door handle IDH. That is, irrespective of the locked state or the unlocked state of the locking mechanism 30, the door D cannot be opened by using the inside door handle IDH.

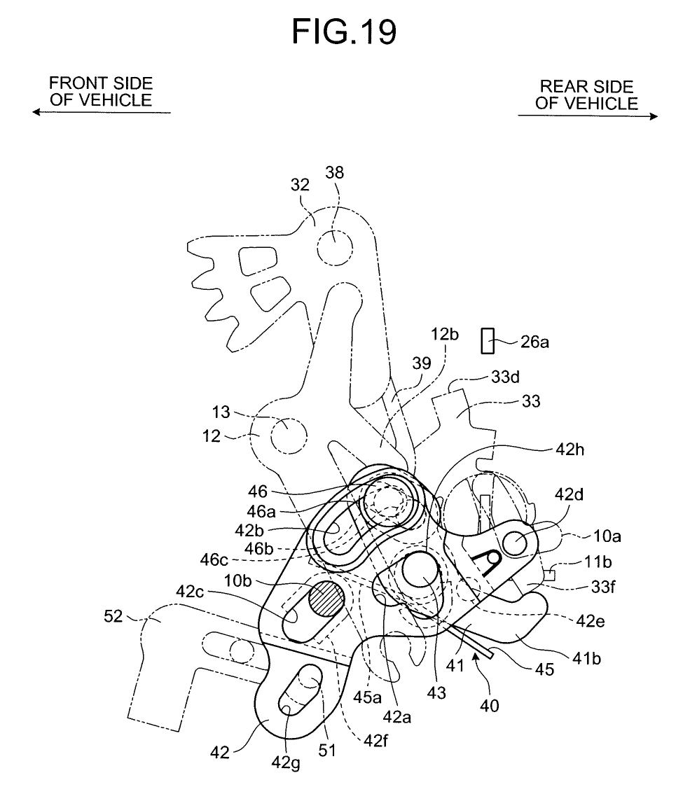

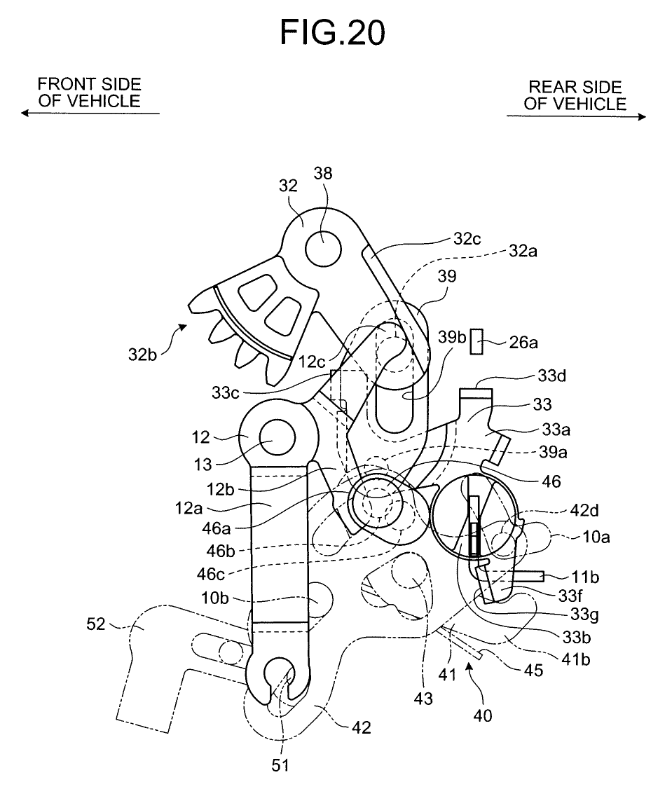

When the manually operated portion 42d is released from the third position, the child-lock lever 42 pivots around the connect lever shaft 43 in anticlockwise direction due to the biasing restoring force of the restoring spring 45 as shown in FIGS. 4 and 19. Consequently, the connect lever shaft 43 is repositioned at the child lock portion 42h and the manually operated portion 42d returns to the second position. The child-lock mechanism 40 is still maintained in the non-transmitting state.

As described above, during the non-transmitting state, the transmitting pin 46c is maintained outside the pivoting area of the inside-handle lock linkage portion 12b. Thus, even if an attempt is made to open the door D by using the inside door handle IDH, the transmitting pin 46c does not abut against the inside-handle lock linkage portion 12b and the connect lever 41 does not pivot. However, the sector lever abutting portion 12c moves the inside-handle-lever abutting portion 32c towards the rear side of the vehicle body B. Consequently, the sector lever 32 pivots in anticlockwise direction with reference to FIGS. 4 and 19 and the coupling pin 32a moves towards the rear side of the vehicle body B. Thus, the link lever 33 pivots in clockwise direction via the panic lever 39.

When the inside door handle IDH is released in such a case, the ratchet driving portion 33d is arranged vertically above the link lever hole 33b such that it lies adjacent to the bottom end of the ratchet abutting portion 26a. As a result, the locking mechanism 30 switches to the unlocked state. When an attempt is made to open the door D by using the outside door handle ODH and the link lever body 33a moves upwards due to the rotation of the open lever 11, the ratchet driving portion 33d abuts against the ratchet abutting portion 26a such that the ratchet abutting portion 26a is rotated upwards. As a result, the latching mechanism 20 is released from the latched state and the door D is opened with respect to the vehicle body B. That is, irrespective of the transmitting state or the non-transmitting state of the child-lock mechanism 40, the locking mechanism 30 can be switched to the unlocked state by using the inside door handle IDH. If the door D is opened thereafter by using the outside door handle ODH, the latching mechanism 20 is released from the latched state.

Usually, the first electric motor 35 can be used to easily switch the locking mechanism 30 between the locked state and the unlocked state.

If the first electric motor 35 does not work properly due to a failure or decrease in the charging voltage of a battery therein (not shown), the manually operated portion 42d can be moved from the first position to the third position via the second position. Consequently, the child-lock lever 42 pivots around the child-lock lever shaft 10b in clockwise direction and moves further to the rear side. As a result, the connect lever shaft 43 is positioned at the emergency lock portion 42i. Moreover, the link lever 33 pivots via the lock operating portion 42e and the locking mechanism 30 switches to the locked state. Although the child-lock lever 42 moves due to the biasing restoring force of the restoring spring 45, the locking mechanism 30 is maintained in the locked state. Thus, the vehicle can be protected from being stolen. Even if the first electric motor 35 does not work properly when a key cylinder is not provided inside the vehicle, it is possible to protect the vehicle from being stolen. Moreover, the direction of the manually operated portion 42d moving from the second position to the third position is perpendicular with the direction of the manually operated portion 42d moving from the first position to the second position. As a result, while moving the manually operated portion 42d from the first position to the second position, there is no possibility of an accidental movement thereof to the third position.

Moreover, if an attempt is made to open the door D y using the inside door handle IDH even when the first electric motor 35 is not working properly, the inside handle lever 12 still causes the locking mechanism 30 to switch to the unlocked state from the locked state. In other words, even if the child-lock mechanism 40 is in the non-transmitting state, the locking mechanism 30 is switched to the unlocked state when, e.g., a child in the vehicle attempts to open the door D by using the inside door handle IDH. Thus, the latching mechanism 20 can be released from the latched state when, e.g., a parent or a guardian attempts to open the door D by using the outside door handle ODH. Thus, even if a key cylinder is not provided inside the vehicle for security purpose, it is possible to open the door D by using the outside door handle ODH. For example, even if the manually operated portion 42d is accidently moved to the third position, the latching mechanism 20 can be released from the latched state by first using the inside door handle IDH and then using the outside door handle ODH. Moreover, when the child-lock mechanism 40 is in the transmitting state and the locking mechanism 30 is in the locked state, the link lever 33 and the panic lever 39 operate the inside handle lever 12 without transmitting the second signal to the latching mechanism 20. Thus, although the locking mechanism 30 is in the unlocked state when an attempt is made to open the door D by using the inside door handle IDH, the latching mechanism 20 can be released from the latched state only when another attempt is made to open the door D by using the inside door handle IDH. As a result, even if, e.g., a parent or a guardian forgets to switch the child-lock mechanism 40 to the non-transmitting state while leaving the vehicle, it is not possible for a child in the vehicle to immediately open the door D by operating the inside door handle IDH.

Moreover, in addition to using the manually operated portion 42d, the child-lock mechanism 40 can be switched from the transmitting state to the non-transmitting state by using the second electric motor 53 under usual conditions. By using the second electric motor 53, the power child-lock lever 52 moves along the longitudinal direction of the second worm 54 via the second output shaft 53a and the second worm 54. Consequently, the child-lock lever 42 is positioned at the second position via the power child-lock pin 51 such that the child-lock mechanism 40 switches to the non-transmitting state.

Thus, according to an aspect of the present invention, even if a key cylinder is not provided on an inner side of a door of a vehicle for security purpose, it is possible to open the door by using an outside door handle. Moreover, even if a parent or a guardian forgets to switch a child-lock mechanism to a non-transmitting state while leaving the vehicle, it is not possible for a child in the vehicle to immediately open the door by operating an inside door handle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A door lock device for a door of a vehicle, the door including an outside door handle arranged on an outer side of the door and an inside door handle arranged on an inner side of the door, the door lock device comprising:
a latching mechanism that, when the door is in a closed position, latches the door in a latched state and restricts movement of the door to an open position;
a locking mechanism that is arranged between the latching mechanism and the outside door handle, and switches between a locked state and an unlocked state, the locking mechanism in the unlocked state transmitting to the latching mechanism a first force regarding an attempt to open the door by using the outside door handle, the locking mechanism in the locked state not transmitting the first force to the latching mechanism, the latching mechanism releasing the door from the latched state upon receiving the first force and allowing movement of the door to the open position;
a door lock actuator that causes the locking mechanism to switch between the locked state and the unlocked state;
a child-lock mechanism that is arranged between the latching mechanism and the inside door handle, and switches between a transmitting state and a non-transmitting state, the child-lock mechanism in the transmitting state transmitting to the latching mechanism a second force regarding an attempt to open the door by using the inside door handle, the child-lock mechanism in the non-transmitting state not transmitting the second force to the latching mechanism;
an inside-door handle lever that operates when the latching mechanism receives the second force and causes the locking mechanism to switch to the unlocked state from the locked state; and
a double action mechanism that, when the child-lock mechanism is in the transmitting state and the locking mechanism is in the locked state, operates the inside-door handle lever without transmitting the second force to the latching mechanism.
